(19) United States
(12) Patent Application Publication
(10) Pub. No.: US 2025/0037439 A1
(43) Pub. Date: Jan. 30, 2025

(54) CLASSIFICATION EVALUATION SUPPORT APPARATUS, CLASSIFICATION EVALUATION SUPPORT METHOD, AND COMPUTER READABLE STORAGE MEDIUM STORING CLASSIFICATION EVALUATION SUPPORT PROGRAM

(71) Applicant: Keyence Corporation, Osaka (JP)

(72) Inventor: Kyosuke TAWARA, Osaka (JP)

(73) Assignee: Keyence Corporation, Osaka (JP)

(21) Appl. No.: 18/739,382

(22) Filed: Jun. 11, 2024

(30) Foreign Application Priority Data
Jul. 27, 2023 (JP) 2023-122407

(51) Int. Cl. G06V 10/776; G06V 10/74; G06V 10/764; G06V 10/98

(52) U.S. Cl. CPC G06V 10/776; G06V 10/761; G06V 10/764; G06V 10/98; G06V 2201/06

(57) ABSTRACT

An apparatus includes a calculation unit that calculates a matching degree of each class of multiple classes for each verification image of a plurality of verification images with which a ground truth class is associated by using the machine learning model, a classification unit that classifies the each verification image into any one of the multiple classes based on the matching degree of the each class calculated for the each verification image, and a display processing unit that displays, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

### CROSS-REFERENCE TO RELATED APPLICATIONS

The present application claims foreign priority based on Japanese Patent Application No. 2023-122407, filed Jul. 27, 2023, the contents of which are incorporated herein by reference.

### BACKGROUND OF THE INVENTION

### 1. Technical Field

The invention relates to a technique for supporting evaluation of accuracy of a machine learning model that classifies images into a plurality of classes.

### 2. Description Of The Related Art

Recently, image inspection (AI image inspection) using a machine learning model has begun to spread. For example, in abnormality detection as an example of AI image inspection, an abnormality degree of each image is calculated, and quality determination is performed based on whether the abnormality degree is equal to or greater than a threshold (see, for example, JP 2023-77059 A). In addition, in multi-class classification that is another example of the AI image inspection, a matching degree of each class for each image is detected, and each image is classified into a class having a highest matching degree.

In the AI image inspection, it is necessary to evaluate how much accuracy of a machine learning model is improved by learning and whether the accuracy is sufficient to start an operation of the image inspection using the machine learning model.

The accuracy of the machine learning model can be evaluated based on whether the machine learning model is correctly determined for a verification image of which a ground truth is known.

In evaluating the accuracy, even though a ground truth rate of the determination for the verification image is 100%, it is not possible to determine with how much time the determination can be correctly made (that is, stability of performance of the machine learning model) only by the ground truth rate.

In a case where the stability of the performance is low, there is a high possibility that an erroneous determination is made after the start of the operation, and thus, it is also important to evaluate the stability of the performance.

In the abnormality detection of JP 2023-77059 A, since one value called the abnormality degree is calculated for one image, for example, the stability can be evaluated by how much an abnormality degree for a non-defective product image group for verification and an abnormality degree for a defective product image group can be separated.

On the other hand, in the machine learning model used for the multi-class classification, matching degrees (also called a confidence degree, a reliability degree, a score, and the like) of a plurality of classes are calculated for one image, and it is necessary to consider not only matching degrees of ground truth classes but also a relative relationship with matching degrees of other classes. Accordingly, unlike the abnormality detection in which only one value of the abnormality degree is calculated, there is a problem that the stability of the performance cannot be easily evaluated in the multi-class classification.

### SUMMARY OF THE INVENTION

The invention has been made in view of the above circumstances, and an object thereof is to provide a technique capable of appropriately evaluating accuracy, particularly stability of performance, of a machine learning model used for classification into a plurality of classes.

In order to achieve the above object, a classification evaluation support apparatus according to one embodiment is a classification evaluation support apparatus that supports evaluation of accuracy of a machine learning model used in classification processing of classifying a predetermined image into any one of multiple classes. The apparatus includes a calculation unit that calculates a matching degree of each class of the multiple classes for each verification image of a plurality of verification images with which a ground truth class is associated by using the machine learning model, a classification unit that classifies the each verification image into any one of the multiple classes based on the matching degree of the each class calculated for the each verification image, and a display processing unit that displays, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

According to the invention, it is possible to appropriately evaluate the accuracy of the machine learning model used for the classification into the plurality of classes, particularly the stability of the performance.

### BRIEF DESCRIPTION OF THE DRAWINGS

FIG. 1 is an overall configuration diagram of an image inspection apparatus according to an embodiment;

FIG. 2 is a hardware configuration diagram of the image inspection apparatus according to the embodiment;

FIG. 3 is a functional configuration diagram of the image inspection apparatus according to the embodiment;

FIG. 4 is a flowchart of machine learning model setting processing according to the embodiment;

FIG. 5 is a configuration diagram of a machine learning model evaluation screen according to the embodiment;

FIGS. 6A and 6B are diagrams illustrating another example of a separation degree graph according to the embodiment;

FIG. 7 is another example of a verification image display region according to the embodiment;

FIG. 8 is a configuration diagram of a matching degree table according to the embodiment;

FIG. 9 is a configuration diagram of a corrected matching degree table according to a modification; and

FIG. 10 is a configuration diagram of a normalized matching degree table according to the modification.

### DETAILED DESCRIPTION

An embodiment will be described with reference to the drawings. Note that, the embodiment to be described below do not limit the invention according to the claims, and all of elements described in the embodiment and combinations thereof are not necessarily essential to the solution of the invention.

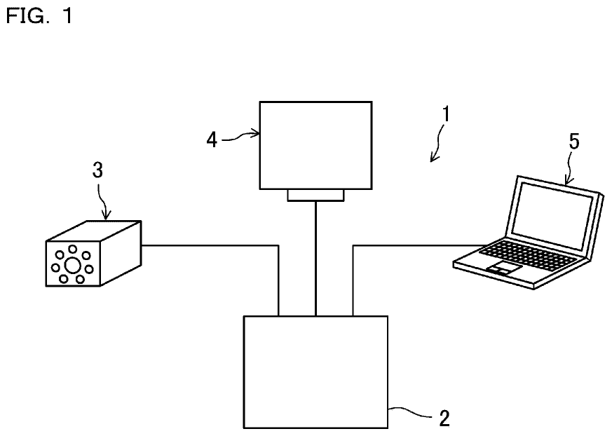

FIG. 1 is an overall configuration diagram of an image inspection apparatus according to an embodiment.

An image inspection apparatus 1 is an example of a classification evaluation support apparatus, and is an apparatus for performing classification processing for classifying which class among a plurality of classes (multiple classes) an inspection target object such as various components and products is (which class does the inspection target object belong), based on an image obtained by capturing the inspection target objects, and is used at a production site such as a factory or the like. An inspection target in the image inspection apparatus 1 may be the entire inspection target object, a part of the inspection target object, or a plurality of parts of the inspection target object. In addition, the image may include a plurality of inspection target objects.

The image inspection apparatus 1 includes a control unit 2, a capturing unit 3, a display device 4, and a personal computer 5. The personal computer 5 is not essential and may be omitted. In addition, the personal computer 5 may be used instead of the display device 4. In addition, the control unit 2 may be realized by the personal computer 5.

In the example of FIG. 1, in the image inspection apparatus 1, the control unit 2, the capturing unit 3, the display device 4, and the personal computer 5 are separated from each other, but a plurality of any configurations may be combined and integrated. For example, the control unit 2 and the capturing unit 3 may be integrated into a so-called smart camera, or the control unit 2 and the display device 4 may be integrated. In addition, the control unit 2 may be divided into a plurality of units, and a part of the divided units may be incorporated into another configuration such as the capturing unit 3 or the display device 4. In addition, the capturing unit 3 may be divided into a plurality of units, and a part of the divided units may be incorporated into another configuration.

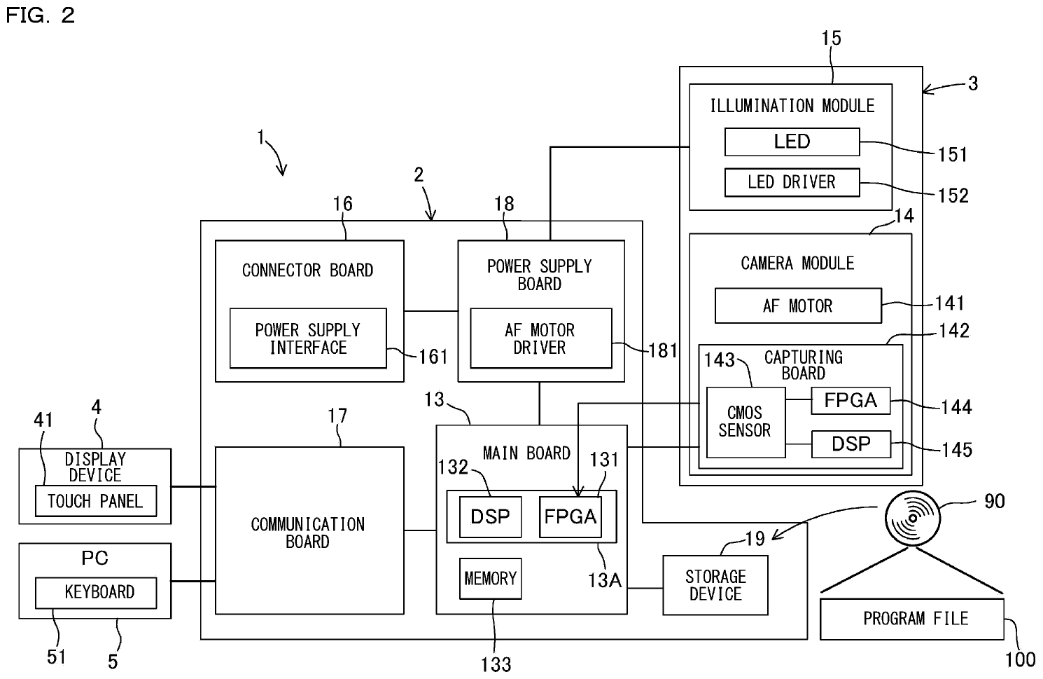

FIG. 2 is a hardware configuration diagram of the image inspection apparatus according to the embodiment.

### Configuration of Capturing Unit 3

The capturing unit 3 includes a camera module 14 and an illumination module 15. The camera module 14 includes an auto focus (AF) motor 141 that drives a capturing optical system, and a capturing board 142. The AF motor 141 automatically executes focus adjustment by driving a lens of the capturing optical system. The focus adjustment of the AF motor 141 is controlled by a known technique such as contrast autofocus.

The capturing board 142 includes a complementary metal-oxide-semiconductor (CMOS) sensor 143, a field programmable gate array (FPGA) 144, and a digital signal processor (DSP) 145, as light receiving elements that receive light incident from the capturing optical system. The CMOS sensor 143 is a capturing sensor configured to be able to acquire a color image. The CMOS sensor 143 is configured to be able to output a live image, that is, a currently captured image at a short frame rate at any time. The CMOS sensor 143 inputs an image (image signal) to the FPGA 144 and the DSP 145. For example, a light receiving element such as a charged-coupled device (CCD) sensor may be used instead of the CMOS sensor 143. The FPGA 144 and the DSP 145 control the camera module 14 and execute predetermined image processing on the image from the CMOS sensor 143. The CMOS sensor 143 starts capturing and performs capturing by adjusting an exposure time to any time in response to a capturing control signal from a controller 13A, to be described later, of the control unit 2. That is, the capturing unit 3 captures an inside of a visual field range of the CMOS sensor 143 in response to the capturing control signal output from the controller 13A. Accordingly, the CMOS sensor 143 captures the inspection target object when the inspection target object is present within the visual field range, and captures an object other than the inspection target object when the object other than the inspection target object is present within the visual field range. For example, at the time of setting the image inspection apparatus 1, the capturing unit 3 can capture a plurality of images for assigning (associating) attributes of ground truth classes of a plurality of classes to be classified by a user. In addition, at the time of operating the image inspection apparatus 1, the capturing unit 3 can capture the inspection target object.

The illumination module 15 includes a light emitting diode (LED) 151 as a light emitter that illuminates a capturing region including the inspection target object, and an LED driver 152 that controls the LED 151. A light emission timing, a light emission time, and a light emission amount of the LED 151 can be randomly set by the LED driver 152. In the example of FIG. 2, the LED 151 is provided integrally with the capturing unit 3, but may be provided as an external illumination unit separate from the capturing unit 3. Note that, although not illustrated, the illumination module 15 includes a reflector that reflects light emitted from the LED 151, a lens through which the light emitted from the LED 151 passes, and the like. In the illumination module 15, an irradiation range of the LED 151 is set such that the inspection target object and a peripheral region of the inspection target object are irradiated with the light emitted from the LED 151. Another light emitter may be used instead of the LED 151. The LED driver 152 switches between turning-on and turning-off of the LED 151 and adjusts a turning-on time in response to an illumination control signal from the controller 13A of the control unit 2, and adjusts a light amount and the like of the LED 151.

### Configuration of Control Unit 2

The control unit 2 includes a main board 13, a connector board 16, a communication board 17, a power supply board 18, and a storage device 19. The FPGA 131 and the DSP 132 constituting the controller 13A and a memory 133 are mounted on the main board 13. Note that, the FPGA 131, the DSP 132, and the memory 133 may be formed as an integrated unit.

The controller 13A integrally controls operations of each substrate and module connected to the main board 13. For example, the controller 13A outputs the illumination control signal for controlling the turning-on and turning-off of the LED 151 to the LED driver 152 of the illumination module 15. In addition, the controller 13A outputs the capturing control signal for controlling the CMOS sensor 143 to the capturing board 142 of the camera module 14. By this capturing control signal, the controller 13A can cause the capturing unit 3 to capture various images. When the capturing by the capturing unit 3 is finished, the controller 13A acquires an image (image signal) output from the capturing unit 3. In the present embodiment, the image signal is input to the FPGA 131, is processed by the FPGA 131 and the DSP 132, and is stored in the memory 133. In addition, the controller 13A outputs an AF control signal for controlling an AF motor driver 181, to be described later, of the power supply board 18.

The connector board 16 includes a power supply interface 161, and receives power supply from an outside via a power supply connector (not illustrated) provided in the original reduction interface 161.

The power supply board 18 distributes the power received by the connector board 16 to each board, module, and the like. Specifically, the power supply board 18 distributes the power to the illumination module 15, the camera module 14, the main board 13, and the communication board 17. The power supply board 18 includes the AF motor driver 181. The AF motor driver 181 supplies drive power to the AF motor 141 of the camera module 14 to realize an autofocus function. The AF motor driver 181 adjusts the power to be supplied to the AF motor 141 in response to the AF control signal from the controller 13A.

The communication board 17 outputs image data, a user interface, and the like of the inspection target object output from the controller 13A to the display device 4, the personal computer 5, an external control device (not illustrated), and the like.

In addition, the communication board 17 receives various operations of the user input from a touch panel 41 of the display device 4, a keyboard 51 of the personal computer 5, and the like. A communication form between the communication board 17 and another device may be wired or wireless, and any communication form can be realized by a known communication module.

The storage device 19 is, for example, a storage device such as a hard disk drive. The storage device 19 stores a program file 100, a setting file (software), a learning image, a verification image, a classification result, and the like for enabling hardware to execute various kinds of processing to be described later. For example, the program file 100 and the setting file may be stored in a computer readable storage medium 90 such as an optical disk, and a program file 80 and a setting file stored in the computer readable storage medium 90 may be installed in the control unit 2.

The display device 4 includes the touch panel 41. The touch panel 41 of the display device 4 displays an image transmitted from the control unit 2, a screen of the user interface, and the like. In addition, the touch panel 41 is, for example, a known touch operation panel having a pressure-sensitive sensor mounted thereon, detects a touch operation by the user, and outputs the touch operation to the communication board 17.

The personal computer 5 includes the keyboard 51, for example, a display panel including a liquid crystal panel, a mouse, and the like. The personal computer 5 receives various operations of the user by an operation device such as the keyboard 51 or a mouse, and transmits the operations to the control unit 2. In addition, the personal computer 5 displays the image transmitted from the control unit 2, the screen of the user interface, and the like.

Next, a functional configuration of the image inspection apparatus 1 will be described.

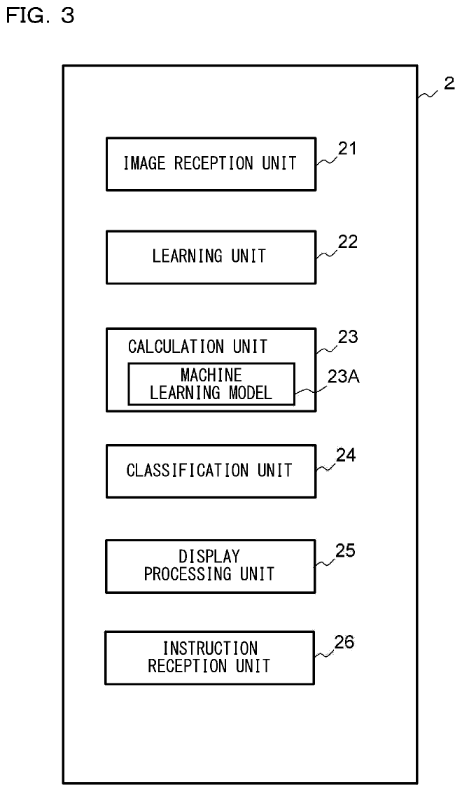

FIG. 3 is a functional configuration diagram of the image inspection apparatus according to the embodiment.

The image inspection apparatus 1 (mainly the control unit 2) includes an image reception unit 21, a learning unit 22, a calculation unit 23, a classification unit 24, a display processing unit 25, and an instruction reception unit 26. Each of these functional units (21 to 26) is configured by, for example, the controller 13A executing the program file 100. Note that, at least one of the functional units may be formed only by hardware.

The image reception unit 21 receives learning images associated with ground truth classes for performing learning on a machine learning model 23A of the calculation unit 23 and a plurality of verification images associated with ground truth classes for evaluating accuracy of the machine learning model 23A. As a method for receiving images such as the learning image and the verification image, designation of a name of an image group or an image name of each image grouped and stored in advance in the storage device 19 or the like may be received. In addition, the image reception unit 21 may receive the designation of the image as the learning image. Note that, the learning image may be included in the verification image.

The learning unit 22 is an example of a learning unit and a relearning unit, and executes machine learning for the machine learning model 23A by using the learning image received by the image reception unit 21.

The calculation unit 23 includes the machine learning model 23A. The machine learning model 23A calculates a matching degree of each class of a plurality of classes that are candidates to be classified for an input image to be processed (target image), and outputs the matching degree. Note that, the machine learning model 23A can be realized by a known model. The calculation unit 23 passes the matching degree of each class of the plurality of classes calculated by the machine learning model 23A to the classification unit 24.

The classification unit 24 classifies the target image based on the matching degree of each class received from the calculation unit 23. Specifically, the classification unit 24 classifies the target image into a class having a highest matching degree.

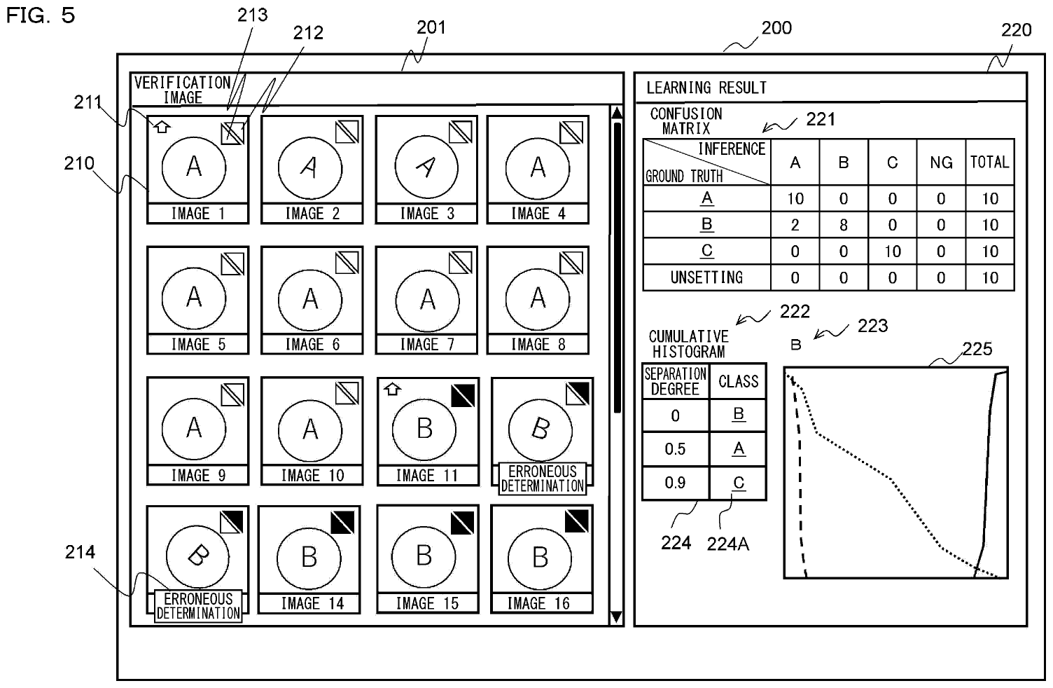

The display processing unit 25 displays a screen of a user interface for evaluation (machine learning model evaluation screen 200 (see FIG. 5)) based on the images of the plurality of verification images and the matching degrees of the classes calculated for the plurality of verification images.

The instruction reception unit 26 receives various instructions from the user via the displayed screen or the like, and notifies the display processing unit 25 of the instructions. For example, the instruction reception unit 26 receives designation of a class (designation class) to be a target of a separation degree graph displayed by the display processing unit 25, and notifies the display processing unit 25 of the designation.

Next, a processing operation by the image inspection apparatus I will be described.

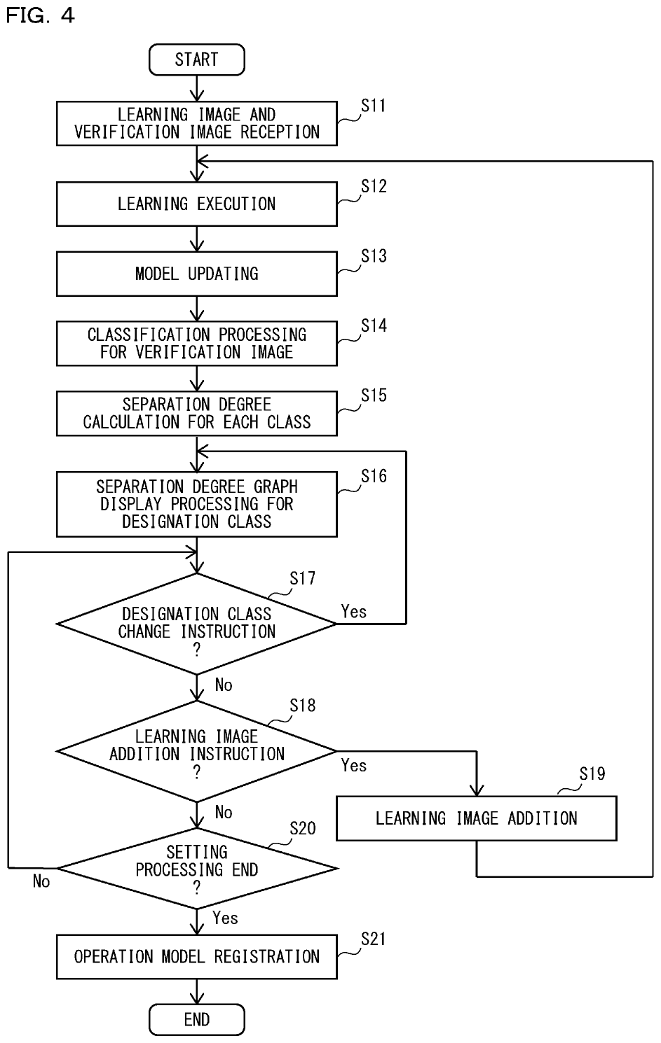

FIG. 4 is a flowchart of machine learning model setting processing according to the embodiment.

The machine learning model setting processing is, for example, processing executed before an operation of the image inspection apparatus 1 is started in inspection for a new inspection target.

First, the image reception unit 21 receives one or more learning images associated with the ground truth classes for performing learning on the machine learning model 23A of the calculation unit 23 and the plurality of verification images associated with the ground truth classes for evaluating the accuracy of the machine learning model 23A (S11).

Subsequently, the learning unit 22 executes machine learning for the machine learning model 23A by using the received learning image (S12). Specifically, when the learning image is input to the machine learning model 23A, the machine learning is performed such that a classification result of the classification unit 24 according to the output from the machine learning model 23A becomes the ground truth class. An existing method can be used as a method of machine learning.

Subsequently, the learning unit 22 updates the machine learning model 23A to a model obtained as a result of the machine learning (S13).

Subsequently, the calculation unit 23 and the classification unit 24 execute classification processing on each verification image (S14). Specifically, the calculation unit 23 calculates the matching degree of each class for each verification image of the plurality of verification images by using the machine learning model 23A updated in step S13, and the classification unit 24 classifies each verification image into a class (inference class) to which the verification image is inferred to belong based on the matching degree of each class calculated for each verification image.

Subsequently, for each verification image group of a set of verification images (verification image group) having a common (identical) ground truth class, the calculation unit 23 calculates a separation degree obtained by subtracting a maximum matching degree among matching degrees of classes other than the ground truth class from a minimum matching degree among the matching degrees of the ground truth classes among the verification images based on the matching degree of each class of each verification image in the verification image group (S15). Note that, in a case where the calculated result is negative, the separation degree is set to 0.

Subsequently, the display processing unit 25 performs separation degree graph display processing of displaying the separation degree graph for the verification image group of the designated class (designation class), and performs processing of displaying the machine learning model evaluation screen 200 (S16). Here, when step S16 is executed for the first time, the designation class may be a predetermined class, for example, a class having a smallest separation degree.

Here, the separation degree graph display processing by the display processing unit 25 will be described by using the machine learning model evaluation screen 200.

FIG. 5 is a configuration diagram of a machine learning model evaluation screen according to the embodiment.

The machine learning model evaluation screen 200 is a screen displayed by the display processing unit 25, and includes a verification image display region 201 and a learning result display region 220.

In the verification image display region 201, a plurality of image-specific regions 210 in which the images are displayed used as the verification image are displayed. In addition, in the image-specific region 210, a ground truth class component 212 indicating a ground truth class for the image in this region and an inference class component 213 indicating an inference class classified by classification processing for the image in this region are displayed in an identifiable manner. Each of the ground truth class component 212 and the inference class component 213 is displayed in a mode (for example, color, pattern, or the like) corresponding to the class. Accordingly, in a case where the ground truth class and the inference class match, that is, in a case where normal determination is made, the ground truth class component 212 and the inference class component 213 are displayed in the same mode. On the other hand, in a case where the ground truth class and the inference class do not match, that is, in a case where erroneous determination is made, the ground truth class component 212 and the inference class component 213 are displayed in different modes. Accordingly, the user can easily grasp whether or not the image is normally determined by referring to the modes of the ground truth class component 212 and the inference class component 213. Note that, in the present embodiment, the display component 214 indicating the erroneous determination is displayed in the image-specific region 210 of the image in which the ground truth class and the inference class do not match. In addition, in the image-specific region 210, in a case where the corresponding image is the learning image, a learning image mark 211 is displayed. In the verification image display region 201, it is also possible to designate addition of the corresponding image as the learning image (learning image addition instruction) by performing a predetermined operation on the image-specific region 210.

A confusion matrix display region 221 and a cumulative histogram display region 222 are displayed in the learning result display region 220. In the confusion matrix display region 221, a confusion matrix indicating a correspondence relationship between the ground truth classes and the inference classes for all the received verification images is displayed. In the confusion matrix, for example, the classes are aligned as the ground truth classes on a vertical axis, the classes are aligned as the inference classes on a horizontal axis, and the number of corresponding verification images is stored in each section corresponding to the ground truth class and the inference class. The display processing unit 25 creates and displays the confusion matrix based on the ground truth classes associated with the verification images and the classification results (inference classes) by the classification unit 24.

In the cumulative histogram display region 222, a designation class 223 indicating the ground truth class that is a current display target, a separation degree table 224 for displaying a separation degree in the verification image group for each ground truth class, and a separation degree graph (evaluation graph) 225 including a cumulative histogram of the matching degree of each class for the verification image group corresponding to the designation class that is the display target are displayed.

In the separation degree table 224, the ground truth class and the separation degree for the ground truth class are displayed in association with each other. In the present embodiment, the user performs an operation of pressing a linked character 224A indicating the ground truth class, the instruction reception unit 26 receives a designation class change indication with the corresponding ground truth class as the designation class. Along with this, the display processing unit 25 creates the separation degree graph for the designation class and displays the separation degree graph in the cumulative histogram display region 222.

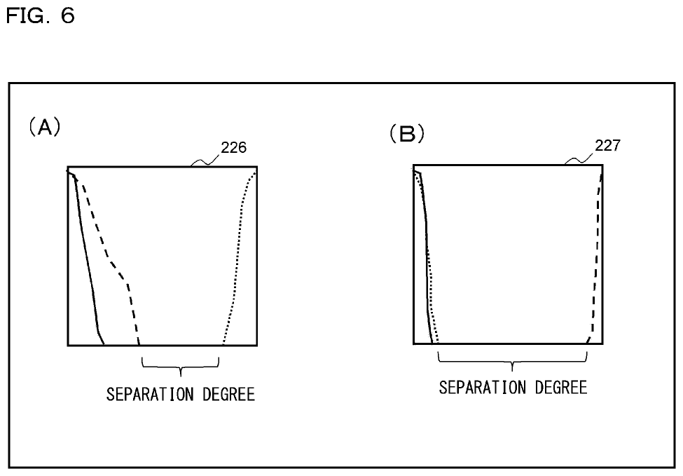

The display processing unit 25 displays, among matching degrees of classes calculated for a verification image group associated with a predetermined ground truth class (for example, B) among a plurality of classes (for example, A, B, and C), a separation degree between a statistic of a matching degree of a predetermined ground truth class and a statistic of matching degrees of the other classes (for example, A and C) that are the classes different from the ground truth class on the display device 4. The display of the separation degree includes not only displaying a numerical values shown in the separation degree table 224 but also displaying a distribution of the matching degree of the ground truth class of the evaluation graph shown in FIGS. 6A and 6B and a distribution of the matching degree of the other class in a distinguished mode.

In the present embodiment, the separation degree based on a “minimum value” of the matching degree of the predetermined ground truth class and a “maximum value” of the matching degree of the other classes that are the classes different from the ground truth class is displayed on the display device 4. In a case where the statistic of the matching degree of the predetermined ground truth class is equal to or less than the statistic of the matching degrees of the other classes, the separation degree may be set to 0.

In a case where the separation degree is calculated as a numerical value, the calculation processing is executed by the display processing unit 25 or the calculation unit 23. In addition, the matching degree of each class may be converted into a corrected matching degree and a normalized matching degree to be described later, and the separation degree may be displayed by a statistic of each converted matching degree.

Note that, not only the minimum value and the maximum value but also a representative value (mean, median, or mode) can be used as the statistic, and a separation degree between a representative value of the matching degree of the ground truth class and a representative value of the matching degrees of the other classes may be displayed on the display device 4. In addition, in a case where a dispersion degree (variance or standard deviation) of the matching degree of the ground truth class and a dispersion degree of the matching degrees of the other classes are equal to or less than a predetermined threshold, the separation degree may be calculated to be high. In an example in which an inappropriate verification image is included from the viewpoint of image quality or the like and an outlier occurs in the matching degree of the ground truth class, the separation degree becomes zero according to the comparison result using the minimum value and the maximum value. However, when the separation degree is based on the representative value, it is possible to perform evaluation while suppressing the influence of the outlier.

In the separation degree graph 225, a horizontal axis (first axis) indicates the matching degree, and a vertical axis (second axis) indicates a value corresponding to the cumulative number of verification images (the cumulative number or a value corresponding to the cumulative number). The separation degree graph 225 includes a cumulative histogram (cumulative graph) of the verification images corresponding to the matching degree of each class for the verification image group associated with the designation class. The cumulative histogram for the ground truth class is configured to accumulate the number of images in a right direction (first direction) in which the matching degree increases, and the cumulative histogram for the classes (other classes) other than the ground truth class is configured to accumulate the number of images in a left direction (second direction) in which the matching degree decreases. In the separation degree graph 225, a difference between the positions in a case where a left end of the cumulative histogram in the ground truth class is on a right side of a right end of the cumulative histogram of the other classes indicates the separation degree. Note that, a case where the left end of the cumulative histogram in the ground truth class is not on the right side of the right end of the cumulative histogram of the other classes indicates that the separation cannot be performed and the separation degree is 0.

A separation degree graph (an example of a first evaluation graph) 225 illustrated in FIG. 5 is a display example for a verification image group (a first verification image group) in which a designation class (ground truth class) is B (an example of a first class), a solid line is a cumulative histogram of a verification image for a matching degree (a first matching degree) of B that is the ground truth class, a dotted line is a cumulative histogram of a verification image for a matching degree (a second matching degree) of A (an example of a second class), and a broken line is a cumulative histogram of a verification image for a matching degree of C. In the separation degree graph 225, since a left end of the cumulative histogram of the ground truth class is not on a right side of a right end of the cumulative histogram of class A, the separation degree is 0. Since the separation degree is 0, it can be evaluated that accuracy of the classification is not high for the verification image of which the ground truth class is B.

Next, a separation degree graph displayed in a case where a linked character of class A in the separation degree table 224 is pressed and a separation degree graph displayed in a case where a linked character of class B is pressed will be described.

FIGS. 6A and 6B are diagrams illustrating another example of the separation degree graph according to the embodiment. FIG. 6A is a separation degree graph displayed when a linked character of class A is pressed, and FIG. 6B is a separation degree graph displayed when a linked character of class C is pressed.

A separation degree graph 226 (an example of a second evaluation graph) illustrated in FIG. 6A is a separation degree graph for a verification image group (an example of a second verification image group) whose ground truth class is A, a dotted line is a cumulative histogram for a matching degree of A that is the ground truth class, a solid line is a cumulative histogram for a matching degree of B, and a broken line is a cumulative histogram for a matching degree of C. In the separation degree graph 226, a left end of the cumulative histogram for A that is the ground truth class is on a right side of a right end of the cumulative histogram for classes B and C, and a difference between the left end and the right end is the separation degree. Here, since the difference thereof is 0.5 in a case where the overall matching degree is 1, the separation degree is 0.5. Since the separation degree is 0.5, it can be evaluated that the verification image of which the ground truth class is A can be classified with relatively high accuracy, particularly, stability of performance of the machine learning model is relatively high.

A separation degree graph 227 illustrated in FIG. 6B is a separation degree graph for a verification image group (an example of a second verification image group) whose ground truth class is C, a broken line is a cumulative histogram for a matching degree of C that is the ground truth class, a solid line is a cumulative histogram for a matching degree of B, and a dotted line is a cumulative histogram for a matching degree of A. In the separation degree graph 227, a left end of the cumulative histogram for C that is the ground truth class is on the right side of the right end of the cumulative histogram for the classes A and B, and the difference between them is the separation degree. Here, since these differences are 0.9 when the overall matching degree is 1, the separation degree is 0.9. Since the separation degree is 0.9, it can be evaluated that the verification image of which the ground truth class is C can be classified with very high accuracy, particularly, the stability of the performance of the machine learning model is very high. That is, it can be evaluated that the stability of the performance of the machine learning model for the verification image whose ground truth class is C is higher than the stability of the performance of the machine learning model for the verification image whose ground truth class is A.

Referring back to the description of FIG. 4, after the machine learning model evaluation screen 200 is displayed in step S16, the instruction reception unit 26 determines whether or not the designation class change instruction is received (S17).

As a result, in a case where the designation class change instruction is received, specifically, in a case where the linked character 224A or the like on the machine learning model evaluation screen 200 is pressed (S17: Yes), the instruction reception unit 26 notifies the display processing unit 25 of the designated class change instruction, and advances the processing to step S16. As a result, the display processing unit 25 creates the separation degree graph corresponding to the designation class and displays the separation degree graph on the machine learning model evaluation screen 200 (S16).

On the other hand, in a case where the designation class change instruction is not received (S17: No), the instruction reception unit 26 determines whether or not an instruction to add the learning image (learning image addition instruction) is received (S18).

As a result, in a case where the instruction to add the learning image is received (S18: Yes), the instruction reception unit 26 adds an image that is a target of the instruction to the learning image (S19), and advances the processing to step S12. As a result, the machine learning model 23A is retrained by using the learning image group including the newly added image, and the new machine learning model 23A can be evaluated. Then, an update matching degree of each class is calculated by using the machine learning model 23A updated in step S13, and the classification unit 24 classifies each verification image again into the class (inference class) to which the verification image is inferred to belong based on the update matching degree of each class calculated for each verification image (S14). The display processing unit 25 updates the separation degree (including the evaluation graph) based on a distribution of an update matching degree of the class and displays the updated separation degree on the display device 4 (S15 and S16).

On the other hand, in a case where the instruction to add the learning image is not received (S18: No), the instruction reception unit 26 determines whether or not the instruction to end the setting processing is received (S20).

As a result, in a case where the instruction to end the setting processing is not received (S20: No), the instruction reception unit 26 advances the processing to step S17. On the other hand, in a case where the instruction to end the setting processing is received (S20: Yes), the instruction reception unit 26 notifies the calculation unit 23 that the instruction to end the setting processing is received, and the calculation unit 23 registers the current machine learning model 23A as the machine learning model (operation model) to be used at the time of operation (S21), and ends the setting processing. As a result, the image inspection apparatus I can operate an appropriate inspection by using a newly registered operation model.

According to the machine learning model setting processing described above, the learned machine learning model 23A can be appropriately evaluated by the separation degree or the like. In addition, the machine learning model 23A with higher classification accuracy can be created by adding the learning image and retraining the machine learning model 23A.

Next, another example of the verification image display region will be described.

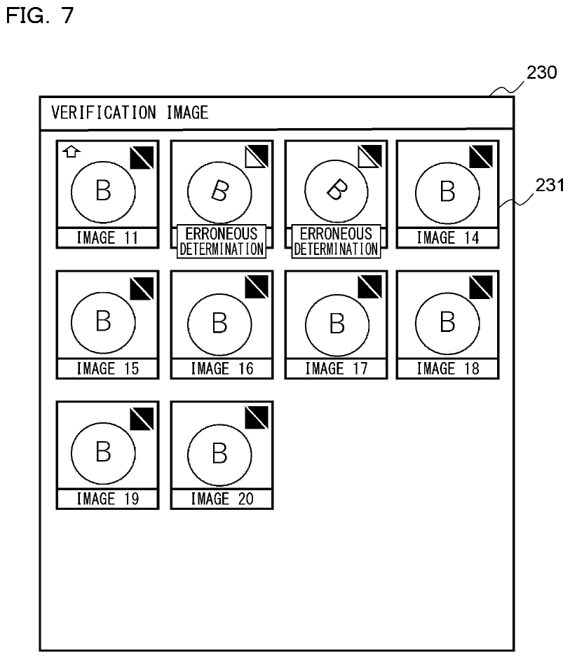

FIG. 7 is another example of the verification image display region according to the embodiment.

In the machine learning model evaluation screen 200 illustrated in FIG. 5, the display processing unit 25 displays the verification image display region 201 including the plurality of image-specific regions 210 for all the images used as the verification images. On the other hand, the display processing unit 25 may preferentially display the verification image associated with the designation class, among the verification images, as illustrated in the verification image display region 230. Here, a case where the display processing unit preferentially displays the verification image includes a case where the display processing unit preferentially displays only the verification image associated with the designation class or a case where the display processing unit preferentially displays the verification image not associated with the designation class but displays the verification images associated with the designation class aligned from a head position (for example, an upper left position) of the verification image display region.

According to such a verification image display region 230, the verification image associated with the designation class can be easily recognized, and the user can easily grasp which classification is made in the verification image associated with the designation class.

Next, an image inspection apparatus according to a modification will be described.

The image inspection apparatus according to the modification is an apparatus that performs additional processing on the calculation unit 23. The calculation unit 23 according to the modification is an example of a corrected matching degree calculation unit.

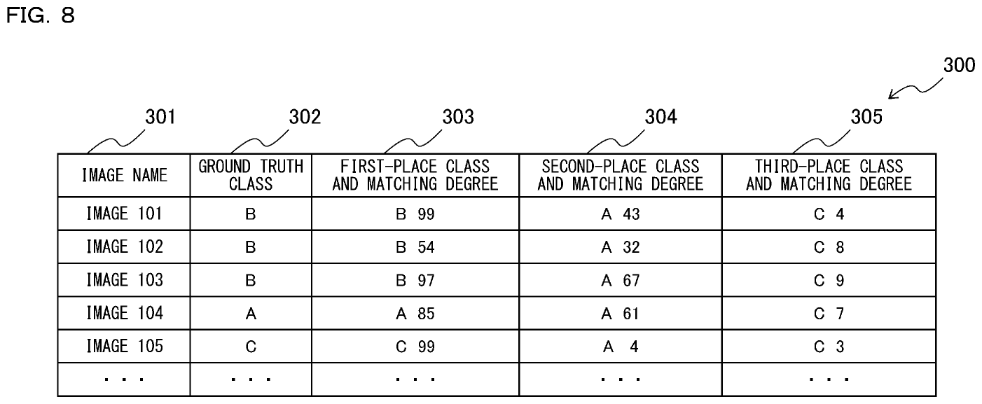

The calculation unit 23 calculates the matching degree of each class for the plurality of verification images by using the machine learning model 23A. The calculation unit 23 manages the matching degree calculated for each verification image by, for example, a working matching degree table 300 (see FIG. 8).

FIG. 8 is a configuration diagram of the matching degree table according to the embodiment.

The matching degree table 300 stores entries for the verification images. Entries of the matching degree table 300 include fields of an image name 301, a ground truth class 302, a first-place class and matching degree 303, a second-place class and matching degree 304, a third-place class and matching degree 305.

Image names corresponding to the verification images corresponding to the entries are stored in the image name 301. Ground truth classes associated with the verification images corresponding to the entries are stored in the ground truth class 302. Maximum (first place) classes (first-place classes) among the matching degrees of the classes calculated for the verification images corresponding to the entries and the matching degrees are stored in the first-place class and matching degree 303. Classes in the second place (second-place classes) among the matching degrees of the classes calculated for the verification images corresponding to the entries and the matching degrees are stored in the second-place class and matching degree 304. Classes in the third place (third-place classes) among the matching degrees of the classes calculated for the verification images corresponding to the entries and the matching degrees are stored in the third-place class and matching degree 305.

In the above embodiment, the separation degree is calculated by using the matching degree calculated by the machine learning model 23A (the matching degree registered in the matching degree table 300), and the separation degree graph is displayed.

Here, for example, as illustrated in the matching degree table 300 illustrated in FIG. 8, the separation degree in a case where the first-place class is B and the matching degree is calculated to be 54 for the verification image of a second entry, the first-place class is B and the matching degree is calculated to be 97 for the image of a third entry, and the second-place class is A and the matching degree is calculated to be 67 will be considered. In this case, in the verification image of the second entry and the verification image of the third entry, the first-place class is B, and the same class as the ground truth class B is appropriately classified as the inference class. In this case, when the separation degree is calculated, since the matching degree of the second-place class of the verification image of the third entry is smaller than the matching degree of the first-place class of the verification image of the second entry, the separation degree becomes 0. Accordingly, there may be a case where the separation degree becomes 0 although classification has been appropriately performed.

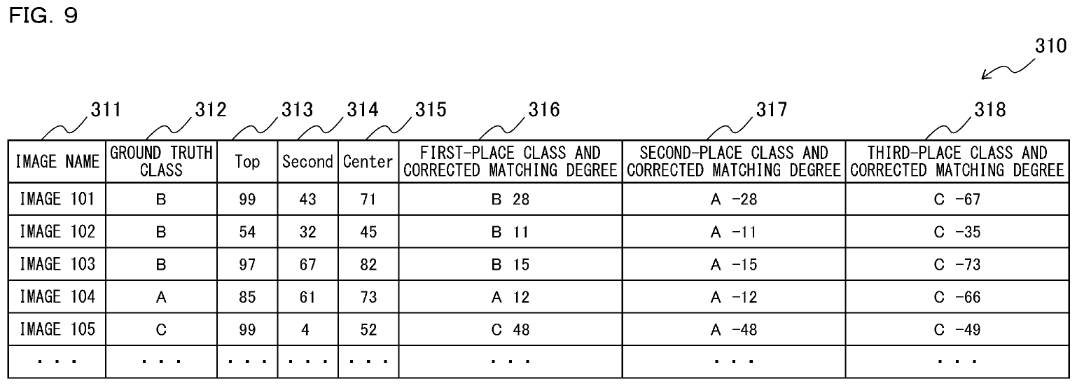

Therefore, the calculation unit 23 according to the modification further determines, as the matching degree for each verification image, a corrected reference value based on a maximum matching degree (first-place matching degree) for the verification image and other matching degrees, and corrects each matching degree based on the reference value to calculate the corrected matching degree of each class. The calculation unit 23 manages the corrected matching degree by, for example, corrected matching degree table 310 (see FIG. 9). Here, the reference value may be a value for an internally dividing point or an externally dividing point between the first-place matching degree and the other matching degree. For example, the other matching degree may be the matching degree in the second place (second-place matching degree). In this case, for example, a value (for example, average value) of the internally dividing point between the first-place matching degree and the second-place matching degree may be used as the reference point.

FIG. 9 is a configuration diagram of a corrected matching degree table according to the modification. The corrected matching degree table 310 of FIG. 9 illustrates an example in which the calculation unit 23 calculates the corrected matching degree by using, as the reference value, the average value of the first-place matching degree and the second-place matching degree for each verification image of the matching degree table 300 illustrated in FIG. 8.

The corrected matching degree table 310 stores entries for the verification images. Entries of the corrected matching degree table 310 include fields of an image name 311, a ground truth class 312, Top 313, Second 314, Center 315, a first-place class and corrected matching degree 316, a second-place class and corrected matching degree 317, and a third-place class and corrected matching degree 318.

Image names corresponding to the verification images corresponding to the entries are stored in the image name 311. Ground truth classes associated with the verification images corresponding to the entries are stored in the ground truth class 312. Matching degrees (first-place matching degrees) of the first-place classes for the verification images for the entries are stored in the Top 313. Matching degrees in the second-place class (second-place matching degrees) for the verification images for the entries are stored in Second 314. Reference values for the verification images for the entries are stored in the Center 315. In the example of FIG. 9, the reference value is an average value of the first-place matching degree and the second-place matching degree.

First-place classes for the verification images corresponding to the entries and corrected matching degrees are stored in the first-place class and corrected matching degree 316. In the example of FIG. 9, the corrected matching degree is a value obtained by subtracting the reference value from the first-place matching degree. Second classes for the verification images corresponding to the entries and corrected matching degrees are stored in the second-place class and corrected matching degree 317. Third-place classes for the verification images corresponding to the entries and corrected matching degrees are stored in the third-place class and corrected matching degree 318.

For example, when processing is performed on a verification image (an image having an image name of image 103) corresponding to the third entry of FIG. 8, as represented in a third entry of the corrected matching degree table 310, “97” is stored in the Top 313, “67” is stored in the Second 314, “82” obtained from (97+67)/2=82 is stored in the Center 315, “15” obtained from 97−82=15 is stored, as the corrected matching degree, in the first-place class and corrected matching degree 316, “−15” obtained from 67−82=−15 is stored, as the corrected matching degree, in the second-place class and the corrected matching degree 317, and “−73” obtained from 9−82=−73 is stored, as the corrected matching degree, in the third-place class and corrected matching degree 318.

The calculation unit 23 may calculate the separation degree by using the corrected matching degree instead of the matching degree. For example, in a case where the matching degree illustrated in FIG. 8 is used, in a case where the separation degree is 0, that is, when the corrected matching degree is used for the verification image of the second entry and the verification image of the third entry, the separation degree can be calculated as 11−(−15)=26, and the separation degree can be appropriately evaluated.

Here, the display processing unit 25 may perform the separation degree graph display processing by using the corrected matching degree instead of the matching degree.

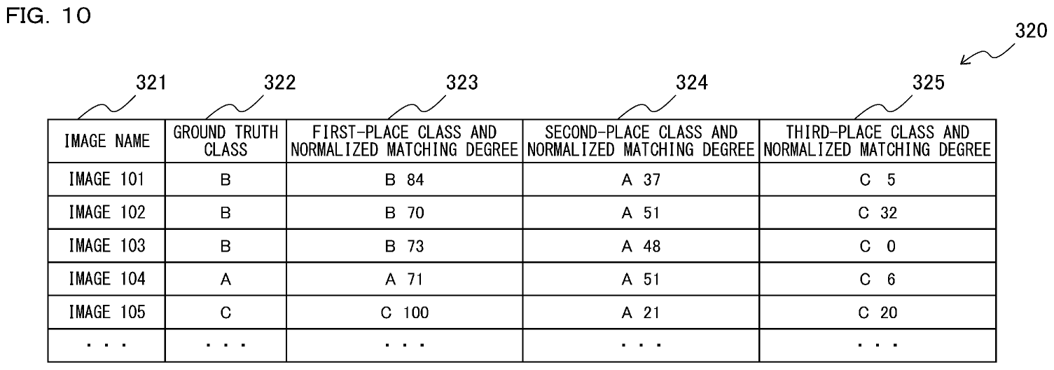

Further, the calculation unit 23 may calculate a matching degree normalized for the corrected matching degree (normalized matching degree). In this case, the calculation unit 23 specifies a maximum value and a minimum value of the corrected matching degrees in all the verification images, and performs normalization such that the maximum value and the minimum value of the corrected matching degrees fall within a predetermined range (for example, 0-100). Here, the calculation unit 23 in this case is an example of a normalized matching degree calculation unit. The calculation unit 23 manages the normalized matching degree (normalized matching degree) for each verification image by using, for example, a normalized matching degree table 320 for work (see FIG. 10).

FIG. 10 is a configuration diagram of a normalized matching degree table according to the modification. The normalized matching degree table 320 of FIG. 10 illustrates an example in which the calculation unit 23 performs normalization on each verification image of the corrected matching degree table 310 illustrated in FIG. 9.

The normalized matching degree table 320 stores entries for the verification images. Entries of the normalized matching degree table 320 include fields of an image name 321, a ground truth class 322, a first-place class and normalized matching degree 323, a second-place class and normalized matching degree 324, a third-place class and normalized matching degree 325.

Image names corresponding to the verification images corresponding to the entries are stored in the image name 321. Ground truth classes associated with the verification images corresponding to the entries are stored in the ground truth class 322. First-place classes for the verification images corresponding to the entries and normalized matching degrees are stored in the first-place class and normalized matching degree 323. Second-place classes for the verification images corresponding to the entries and normalized matching degrees are stored in the second-place class and normalized matching degree 324. Third-place classes for the verification images corresponding to the entries and normalized matching degrees are stored in the third-place class and normalized matching degree 325.

For example, when processing is performed on a verification image (an image having an image name of image 103) corresponding to the third entry of FIG. 9, as represented in a third entry of the normalized matching degree table 320, “73” is stored as, the normalized matching degree, in the first-place class and normalized matching degree 323, “48” is stored, as the normalized matching degree, in the second-place class and normalized matching degree 324, and “0” is stored, as the normalized matching degree, in the third-place class and normalized matching degree 325.

The calculation unit 23 may calculate the separation degree by using the normalized matching degree instead of the matching degree. In addition, the display processing unit 25 may perform the separation degree graph display processing by using the normalized matching degree instead of the matching degree.

Note that, the invention is not limited to the above-described embodiment and modification, and can be appropriately modified and implemented without departing from the gist of the invention.

For example, in the above embodiment, the separation degree graph includes a distribution graph of the matching degree of the class, but the invention is not limited thereto, and for example, the separation degree graph may include a distribution graph of ground truth classes and a distribution graph in which other classes are collected.

In addition, the invention includes, for example, a classification evaluation support apparatus, a classification evaluation support method, and a computer readable storage medium storing a classification evaluation support program according to the following Appendixes 1 to 15.

### Appendix 1

A classification evaluation support apparatus that supports evaluation of accuracy of a machine learning model used in classification processing of classifying a predetermined image into any one of multiple classes, the apparatus including:
a calculation unit that calculates a matching degree of each class of the multiple classes for each verification image of a plurality of verification images with which a ground truth class is associated by using the machine learning model;
a classification unit that classifies the each verification image into any one of the multiple classes based on the matching degree of the each class calculated for the each verification image; and
a display processing unit that displays, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

### Appendix 2

The classification evaluation support apparatus according to Appendix 1, in which the statistic of the matching degrees of the ground truth class is a minimum value of the matching degrees of the ground truth class, and the statistic of the matching degree of the other class is a maximum value of the matching degrees of the other class, and
the display processing unit displays, on the display device, the separation degree between the minimum value of the matching degrees of the ground truth class and the maximum value of the matching degrees of the other class.

### Appendix 3

The classification evaluation support apparatus according to Appendix 1 or Appendix 2, in which, when the verification image group associated with the predetermined ground truth class is selected, the display processing unit generates an evaluation graph displayed in a mode in which a distribution of the matching degrees of the predetermined ground truth class and a distribution of the matching degrees of the other class are distinguished, and displays the evaluation graph on the display device.

### Appendix 4

The classification evaluation support apparatus according to Appendix 3, in which the display processing unit creates the evaluation graph for each ground truth class corresponding to each of the multiple classes, and displays the evaluation graph for each ground truth class.

### Appendix 5

The classification evaluation support apparatus according to Appendix 3 or Appendix 4, in which three or more classes are included in the multiple classes, and two or more classes are included in the other class, and
the display processing unit displays the evaluation graph including the distribution of the matching degrees for each class included in the other class.

### Appendix 6

The classification evaluation support apparatus according to any one of Appendix 1 to Appendix 5,
in which the multiple classes include a first class and a second class,
the calculation unit calculates a first matching degree of the first class and a second matching degree of the second class for the each verification image,
the display processing unit generates, for a first verification image group of which the ground truth class is the first class, a first evaluation graph displayed in a mode in which a distribution of the first matching degree of each verification image of the first verification image group and a distribution of the second matching degree of the each verification image of the first verification image group are distinguished, and generates, for a second verification image group of which the ground truth class is the second class, a second evaluation graph displayed in a mode in which a distribution of the first matching degree of the each verification image of the second verification image group and a distribution of the second matching degree of the each verification image of the second verification image group are distinguished, and
displays at least one of the first evaluation graph or the second evaluation graph on the display device.

### Appendix 7

The classification evaluation support apparatus according to Appendix 6,
in which, in a case where the first evaluation graph regarding the first verification image group is displayed in preference to the second evaluation graph regarding the second verification image group on the display device, the display processing unit displays the first verification image group in preference to the second verification image group on the display device, and displays the first class that is the ground truth class and an inference class obtained by classifying the each verification image of the first verification image group in an identifiable manner.

### Appendix 8

The classification evaluation support apparatus according to any one of Appendix 3 to Appendix 7, further including:
a corrected matching degree calculation unit that determines, for the each verification image, a correction reference value of the matching degree of the verification image based on a maximum matching degree and another matching degree among the matching degrees of the classes for the verification images, corrects the matching degree of the each class for the verification image based on the correction reference value, and calculates a corrected matching degree,
in which the display processing unit displays the evaluation graph by using the corrected matching degree instead of the matching degree.

### Appendix 9

The classification evaluation support apparatus according to Appendix 8, in which the corrected matching degree calculation unit determines, as the correction reference value, an internally dividing point or an externally dividing point between the maximum matching degree and a second largest matching degree of the verification image.

### Appendix 10

The classification evaluation support apparatus according to Appendix 9, in which the corrected matching degree calculation unit determines, as the correction reference value, an average value of the maximum matching degree of the verification image and the second largest matching degree.

### Appendix 1

The classification evaluation support apparatus according to any one of Appendix 8 to Appendix 10, further including:
a normalized matching degree calculation unit that generates a normalized matching degree obtained by normalizing the corrected matching degree of the each verification image such that a maximum corrected matching degree in all verification images of the verification images and a minimum corrected matching degree fall in a predetermined range,
in which the display processing unit creates the evaluation graph by using the normalized matching degree instead of the matching degree.

### Appendix 12

The classification evaluation support apparatus according to any one of Appendix 3 to Appendix 11, in which the evaluation graph is a cumulative graph in which a matching degree is depicted on a predetermined first axis, information corresponding to the number of verification images is depicted on a second axis intersecting the first axis, and
in the cumulative graph, information corresponding to the number of verification images is accumulated in a first direction of the first axis for the matching degree of the ground truth class, and information corresponding to the number of verification images in a second direction opposite to the first direction for the matching degree of the other class.

### Appendix 13

The classification evaluation support apparatus according to any one of Appendix 1 to Appendix 12, further including:
a reception unit that receives designation of an image newly used as a learning image from among a plurality of the verification images displayed on the display device in an identifiable manner by the display processing unit; and
a learning unit that learns the machine learning model by a learning image including the received image,
in which the learning unit is configured to be able to train the machine learning model by using a verification image erroneously classified into the other class among the verification image group classified by the classification unit,
the calculation unit calculates an update matching degree of the each class of the each verification image by using the machine learning model trained by the learning unit,
the classification unit classifies the each verification image into any one of the multiple classes again based on the update matching degree of each class, and
the display processing unit displays the separation degree on the display device by using the update matching degree instead of the matching degree.

### Appendix 14

A classification evaluation support method by a classification evaluation support apparatus that supports evaluation of accuracy of a machine learning model used in classification processing of classifying a predetermined image into any one of multiple classes, the method including:
calculating a matching degree of each class of the multiple classes for each verification image of a plurality of verification images with which a ground truth class is associated by using the machine learning model,
classifying the each verification image into any one of the multiple classes based on the matching degree of the each class calculated for the each verification image, and
displaying, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

### Appendix 15

A computer readable storage medium storing a classification evaluation support program that supports evaluation of accuracy of a machine learning model used in classification processing of classifying a predetermined image into any one of multiple classes, the classification evaluation support program comprising instructions, which when executed by a computer, cause the computer to:
calculate a matching degree of each class of the multiple classes for each verification image of a plurality of verification images with which a ground truth class is associated by using the machine learning model;
classify the each verification image into any one of the multiple classes based on the matching degree of the each class calculated for the each verification image; and
display, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

What is claimed is:

1. A classification evaluation support apparatus that supports evaluation of accuracy of a machine learning model used in classification processing of classifying a predetermined image into any one of multiple classes, the apparatus comprising:
a calculation unit that calculates a matching degree of each class of the multiple classes for each verification image of a plurality of verification images with which a ground truth class is associated by using the machine learning model;
a classification unit that classifies the each verification image into any one of the multiple classes based on the matching degree of the each class calculated for the each verification image; and
a display processing unit that displays, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

2. The classification evaluation support apparatus according to claim 1, wherein
the statistic of the matching degrees of the ground truth class is a minimum value of the matching degrees of the ground truth class, and the statistic of the matching degrees of the other class is a maximum value of the matching degrees of the other class, and
the display processing unit displays, on the display device, the separation degree between the minimum value of the matching degrees of the ground truth class and the maximum value of the matching degrees of the other class.

3. The classification evaluation support apparatus according to claim 1, wherein, when the verification image group associated with the predetermined ground truth class is selected, the display processing unit generates an evaluation graph displayed in a mode in which a distribution of the matching degrees of the predetermined ground truth class and a distribution of the matching degrees of the other class are distinguished, and displays the evaluation graph on the display device.

4. The classification evaluation support apparatus according to claim 3, wherein the display processing unit creates the evaluation graph for each ground truth class corresponding to each of the multiple classes, and displays the evaluation graph for each ground truth class.

5. The classification evaluation support apparatus according to claim 3, wherein
three or more classes are included in the multiple classes, and two or more classes are included in the other class, and
the display processing unit displays the evaluation graph including the distribution of the matching degrees for each class included in the other class.

6. The classification evaluation support apparatus according to claim 1, wherein
the multiple classes include a first class and a second class,
the calculation unit calculates a first matching degree of the first class and a second matching degree of the second class for the each verification image,
the display processing unit generates, for a first verification image group of which the ground truth class is the first class, a first evaluation graph displayed in a mode in which a distribution of the first matching degree of each verification image of the first verification image group and a distribution of the second matching degree of the each verification image of the first verification image group are distinguished, and generates, for a second verification image group of which the ground truth class is the second class, a second evaluation graph displayed in a mode in which a distribution of the first matching degree of the each verification image of the second verification image group and a distribution of the second matching degree of the each verification image of the second verification image group are distinguished, and
displays at least one of the first evaluation graph or the second evaluation graph on the display device.

7. The classification evaluation support apparatus according to claim 6, wherein in a case where the first evaluation graph regarding the first verification image group is displayed in preference to the second evaluation graph regarding the second verification image group on the display device, the display processing unit displays the first verification image group in preference to the second verification image group on the display device, and displays an inference class obtained by classifying the each verification image of the first verification image group by the classification unit.

8. The classification evaluation support apparatus according to claim 1, further comprising a corrected matching degree calculation unit that determines, for the each verification image, a correction reference value of the matching degree of the verification image based on a maximum matching degree and another matching degree among the matching degrees of the classes for the verification images, corrects the matching degree of the each class for the verification image based on the correction reference value, and calculates a corrected matching degree,
wherein the display processing unit displays the separation degree on the display device by using the corrected matching degree instead of the matching degree.

9. The classification evaluation support apparatus according to claim 8, wherein the corrected matching degree calculation unit determines, as the correction reference value, an internally dividing point or an externally dividing point between the maximum matching degree and a second largest matching degree of the verification image.

10. The classification evaluation support apparatus according to claim 9, wherein the corrected matching degree calculation unit determines, as the correction reference value, an average value of the maximum matching degree of the verification image and the second largest matching degree.

11. The classification evaluation support apparatus according to claim 8, further comprising a normalized matching degree calculation unit that generates a normalized matching degree obtained by normalizing the corrected matching degree of the each verification image such that a maximum corrected matching degree in all verification images of the verification images and a minimum corrected matching degree fall in a predetermined range,
wherein the display processing unit displays the separation degree on the display device by using the normalized matching degree instead of the matching degree.

12. The classification evaluation support apparatus according to claim 3, wherein the evaluation graph is a cumulative graph in which a matching degree is depicted on a predetermined first axis, information corresponding to the number of verification images is depicted on a second axis intersecting the first axis, and
in the cumulative graph, information corresponding to the number of verification images is accumulated in a first direction of the first axis for the matching degrees of the ground truth class, and information corresponding to the number of verification images in a second direction opposite to the first direction for the matching degrees of the other class.

13. The classification evaluation support apparatus according to claim 1, further comprising:
a reception unit that receives designation of an image newly used as a learning image from among a plurality of the verification images displayed on the display device in an identifiable manner by the display processing unit; and
a learning unit that learns the machine learning model by a learning image including the received image,
wherein
the learning unit is configured to be able to train the machine learning model by using a verification image erroneously classified into the other class among the verification image group classified by the classification unit,
the calculation unit calculates an update matching degree of the each class of the each verification image by using the machine learning model trained by the learning unit,
the classification unit classifies the each verification image into any one of the multiple classes again based on the update matching degree of each class, and
the display processing unit displays the separation degree on the display device by using the update matching degree instead of the matching degree.

14. A classification evaluation support method by a classification evaluation support apparatus that supports evaluation of accuracy of a machine learning model used in classification processing of classifying a predetermined image into any one of multiple classes, the method comprising:
calculating a matching degree of each class of the multiple classes for each verification image of a plurality of verification images with which a ground truth class is associated by using the machine learning model,
classifying the each verification image into any one of the multiple classes based on the matching degree of the each class calculated for the each verification image, and
displaying, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.

15. A computer readable storage medium storing a classification evaluation support program that supports evaluation of accuracy of a machine learning model used in classification processing of classifying a predetermined image into any one of multiple classes, the classification evaluation support program comprising instructions, which when executed by a computer, cause the computer to:
calculate a matching degree of each class of the multiple classes for each verification image of a plurality of verification images with which a ground truth class is associated by using the machine learning model;
classify the each verification image into any one of the multiple classes based on the matching degree of the each class calculated for the each verification image; and
display, on a predetermined display device, a separation degree between a statistic of matching degrees of the ground truth class and a statistic of matching degrees of other class that is a class different from the ground truth class, among the matching degrees of the each class calculated for a verification image group associated with a predetermined ground truth class.
